(19) United States
(12) Patent Application Publication
(10) Pub. No.: US 2024/0254669 A1
(43) Pub. Date: Aug. 1, 2024

(54) METHOD OF MANUFACTURING HYBRID ADDITIVE FABRIC, THE FABRIC, AND TOOLS FOR MANUFACTURING FABRIC

(71) Applicant: ZEPHLINEAR LTD, Nottingham Nottinghamshire (GB)

(72) Inventor: Sonia Michelle REYNOLDS, Nottingham (GB)

(73) Assignee: ZEPHLINEAR LTD, Nottingham Nottinghamshire (GB)

(21) Appl. No.: 18/289,216

(22) PCT Filed: Apr. 29, 2022
(86) PCT No.: PCT/GB2022/051098

§ 371 Date: Nov. 1, 2023

(30) Foreign Application Priority Data
May 2, 2021 (GB) 2106303.7

(51) Int. Cl. D04H 3/16; B29C 64/118; B29C 64/209; B29C 64/30; B29K 105/08; B29L 31/00; B33Y 10/00; B33Y 30/00; B33Y 80/00; D04H 1/74; D04H 3/10

(52) U.S. Cl. CPC D04H 3/16; B29C 64/118; B29C 64/209; B29C 64/30; B33Y 10/00; B33Y 30/00; B33Y 80/00; D04H 1/74; D04H 3/10; B29K 2105/0809; B29L 2031/726

(57) ABSTRACT

The present invention relates to a method of manufacturing a fabric, and the fabric made by the method. Fabric made from yarn or filament is currently produced by either a knitting process which involves the interloping of yarn, or a weaving process which involves the interlacing of yarn, or the entanglement of fibre on the surface of yarn. These construction methods have a definite look, texture and functionality. The invention seeks to provide an alternative fabric construction especially for yarn, filament, thread and fine wires or such like. A method of manufacturing a fabric by laying a parallel surface of yarn, such as spun yarn, wire, thread or such like, then a second layer of parallel array of filament at an 90-degree angle dispensed from a 3D printer or 3D printer pen. Yarn and filament can be layered in a variety of designs and not limited to a parallel array of yarn to accommodate unlimited design shapes and structures. The method can be repeated to create a fabric surface built by multiple layers upon layer. Alternating one layer of yarn or such like and one layer of 3D printed filament. Each layer offers space to embed components such as semi-conductors. Semi-conductors that are an essential component of electronic devices, enabling advances in communications, computing, healthcare, military systems, transportation, clean energy, and countless other applications. In addition, Drug delivery scaffolds that allow for controlled spatiotemporal releases to active compounds can also be accommodated within the layer of spun yarn and 3D filament. The spun yarn or filament can be embedded with conductive yarns or E-yarns to enhance functionality further. The surface of the spun yarn may be brushed to raise the surface fibres, to increase the entanglement and enhance the blending of spun yarn and the fluid filament dispensed via a 3D printer or 3D pen. The combination of 3D printing and spun yarn or such like provides an additive manufactured hybrid textile. Therefore, the present invention offers numerous advantages over woven, knitted or parallel layered fibre on yarn entangled fabric surfaces.

The present invention relates to a method of manufacturing a fabric, and the fabric made by the method. Fabric made from yarn is currently produced by either a knitting process which involves the interlooping of yarn, or a weaving process which involves the crossing over and under of yarn, or the entanglement of fibre on yarn. These construction methods have a definite look and texture. There is thus a limitation in the end appearance of functionality. The invention seeks to provide an alternative fabric construction especially for spun yarn, filament, thread and fine wires by an additive method. The new process combines 3D printing and yarn or such like e.g., wire or thread to create what can be considered as a hybrid fabric surface.

According to the present invention there is provided a method of manufacturing a fabric comprising: a) laying out first lengths of spun yarn, thread or wire in a parallel array, or a desired shape; and b) laying out a second layer of 3D filament in an array or a desired shape to entangle with fibres on surface of yarns in the array or stick to thread or wire, and the 3D printer filament.

The method may further comprise laying out second, third and multiple layers of spun yarn, thread or wire and 3D pen filament to create a multiple layered textile fabric.

Preferably if spun yarn is used the method further comprises releasing fibres on the surface of yarn by brushing the yarn to raise fibre from the yarn.

Preferably the brushing of the yarn is done with a rotating brush or a board with a flat hooked surface such as Velcro hook.

Preferably the method of connecting the surface fibre of yarn and the 3D filament is by wetting the yarns with the heated 3D filament which becomes liquidized through heat.

Preferably the wet 3D filament blending with the fibre of the yarn surface provides entangling sufficient to form a fabric structure when dried.

According to a further aspect of the invention, there is provided a method of manufacturing a fabric comprising: a) laying out first lengths of spun yarn, thread or wire in a parallel array or desired shape, b) wetting the yarns in the array with 3D printer filament to blend and entangle surface fibres of yarns in the array, and c) 3D filament.

According to a further aspect of the invention, there is provided an apparatus for manufacturing the fabric comprising: a) a pen shaped feed tool with yarn holder to lay out spun yarns into a first parallel array, or desired shape b) a dispenser feed attached to a 3D printer pen to apply components onto layer of 3D filament and surface of yarn, thread wire or second filament.

Embodiments of the invention will now be described with reference to the accompanying drawing in which:

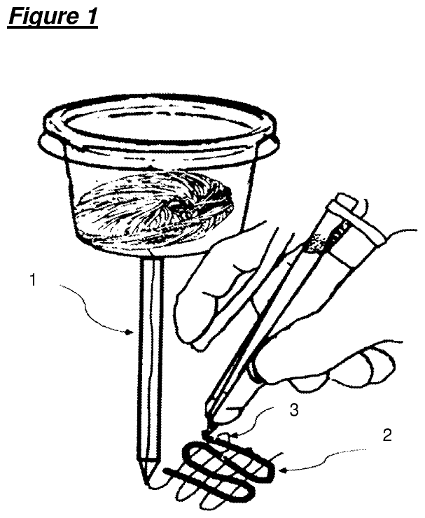

FIG. 1, reference 1 indicates a yarn feed pen with yarn holder;

FIG. 1, reference 2 indicates an existing 3D printing pen used to place filament; and

FIG. 1, reference 3 indicates an attachable dispenser feed to place components onto 3D filament.

Referring to FIG. 1 there is shown tools for manufacturing fabric.

As shown in FIG. 1 first feed tool 1 with spun yarn is provided to lay out spun yarns into a first parallel array. This could be single yarns side by side or double or more layers of single yarns side by side, e.g., of different texture, colour, technical functionality. In addition, yarns can be layered in various shapes not limited to side by side. In addition, yarn can be replaced with wire, thread, or bespoke filament. Via a 3D pen a layer of filament 2 is placed onto spun yarn or such like. The filament is heated and when dry will entangle and blend with yarn surface to create a fabric. Components 3 can be easily added to filament to further advance the functionality of the fabric.

The fabric of the invention has numerous advantages. Smart components such as semi-conductors can be added to the yarns. Wires, filaments or thread before they are assembled into an array or preferred shape giving endless functionality and creative potential to the fabric. The air retained within the entangled fibres and the 3D filament result in a construction which is formed from a high percentage of air, e.g. the fabric can be constructed to be 40% air. The open structure provides a transparent fabric surface providing a lightweight fabric. Controlling degree of space between fibres allows easy control of ventilation and insulation properties in the fabric. The manufacturing process is additive therefore layer by layer providing smart materials, eco and sustainable structures and components to be layered between the layers of fibre of yarn, filament and wire and 3D printing filament. There is no interlocking or crossing over of the yarns or filament, which provides space for large components such as circuit boards or drug delivery scaffolds to be easily embedded between the layers which is not possible when using the knitting or weave process. The manufacturing process is much quicker than with fabrics which use the knitting or weave process. The process is easy to use and does not need large or complicated machinery to produce large or small fabric surfaces. The process creates textile fabrics in a rapid time frame and can be used in a small environment such as a laboratory, small studio or private dwellings. The process when embedded with semi-conductors for tracking or monitoring can be easily incorporated with adhesive wound dressing and trauma dressing to enhance functionality. The new invention provides a method to create textiles in a simple and cost efficient in comparison to traditional methods. In addition, extremely small areas can be manufactured for rapid prototyping while reducing waste due to the removal for the need for large machinery.

The invention may take a form different to that specifically described above.

Further modifications will be apparent to those skilled in the art without departing from the scope of the present invention.

1. A method of manufacturing a fabric comprising:
a) laying out first lengths of spun yarn or such like in a parallel array or desired shape,
b) placing 3D filament onto yarns in the array or desired shape to entangle surface fibres of yarns and c) drying the wet fibre on the yarns and the 3D printer filament.

2. A method according to claim 1, further comprising laying out second layer of 3D printer filament in a parallel array or desired design on top of the first layer of yarns.

3. A method according to claim 1 or 2, further comprising releasing fibres on the surface of each length of yarn in the array by brushing the yarn to enhance connectivity to 3D filament.

4. A method according to claim 3, wherein the brushing of the yarn is done with a brush or a flat block with hooks to raise fibre from the yarn surface.

5. A method according to any preceding claim, wherein the method of wetting the yarns with 3D filament top layer to entangle the surface fibres with the filament.

6. A method according to claim 5, wherein the connecting of the surface fibres is sufficient to form entanglement of fibre and filament to form a fabric flexible fabric surface.

7. A fabric made by the method of any preceding claim.

8. An apparatus for manufacturing the fabric comprising:
a) a first feed station in the form of a pen with yarn feed and yarn holder to lay out spun yarns or such like into a first parallel array or desired shape;
b) a flat surface with pegs or hooks on the base to grip first layer of fibre or filament in place;
c) a flat surface to hold first layer of yarn or such like preferably Velcro hooks;
d) a feed to release the 3D printer filament either via a 3D printer or a 3D printer pen to entangle surface fibres of yarns in the array, and the 3D filament.

9. An apparatus according to claim 8, wherein a 3D pen and additional feed is provided to lay out filament onto spun yarns.

10. An apparatus according to claim 8 or 9, wherein a brushing is provided to release fibres on the surface of yarn in the array, to entangle and blend fibre on yarn with 3D printer filament.

11. A method according to claim 1, can be further advanced by use of large 3D printer in replacement of 3D pen.

12. A method according to claim 1, can be further advanced by use of powered machine to lay out spun yarn in replacement of yarn pen tool.
